(19) United States
(12) Patent Application Publication
(10) Pub. No.: US 2011/0169709 A1
(43) Pub. Date: Jul. 14, 2011

(54) Combination Shield and Mount for Antenna

(76) Inventor: Henry Cooper, Murrieta, CA (US)

(21) Appl. No.: 12/419,266

(22) Filed: Apr. 6, 2009

Related U.S. Application Data
(60) Provisional application No. 61/075,296, filed on Jun. 24, 2008.
(60) Provisional application No. 61/118,549, filed on Nov. 28, 2008.
(60) Provisional application No. 61/042,737, filed on Apr. 5, 2008.
(60) Provisional application No. 61/042,752, filed on Apr. 6, 2008.

(51) Int. Cl. H01Q 1/52

(52) U.S. Cl. 343/841

(57) ABSTRACT

A combination antenna mount and shield for radially deployed elevated antennas on poles. The device features a central cavity surrounded by a wall of material which is substantially impervious to Radio Frequency (RF) broadcasts.

A plurality of fins radially projecting from front face of the wall for a projection distance provides a series of gaps therebetween around said wall. Antennas positioned in the gaps are shielded from interference from adjoining antennas in adjoining gaps by the projecting walls.

### BACKGROUND OF THE INVENTION

1. Field of the Invention

This application is claims priority to U.S. Provisional Application 61/075,296 filed Jun. 24, 2008 and U.S. Provisional Application 61,118,549 filed Nov. 28, 2008, and U.S. Provisional Application 61,042,737 filed Apr. 5, 2008, and U.S. Provisional Application 61,042,752 filed Apr. 6, 2008, all four of which are incorporated herein in their entirety by reference. The present invention relates to antennas. More particularly it relates to a device and method for engagement of directional antennas employed in a wireless mesh or cellular type installation.

2. Prior Art

Conventionally, antennas are formed in a structure that may be adjustable for frequency and gain by changing the formed structure elements. Shorter elements for higher frequencies, longer elements for lower, and pluralities of similar elements to increase gain. The antenna structure holding the antennas are generally omni directional in that a plurality of antenna having elements at the correct frequency, at correct radial angels, and face angles to others in the system, are engaged to the top of the broadcast tower.

Because the antennas are adjacent and may be on the same frequency, it is important they not interfere with each other which is a distinct possibility since many antennas are designed to take advantage of a symbiotic relationship with an adjacent antenna. Additionally, the construction of such towers is such that they are generally elevated from the ground and hard to work upon and dangerous to work on since the worker must be elevated in a bucket to do so high above the ground.

As such, when constructing a communications array such as a cellular antenna grid, or a wireless communications web, the builder is faced with the dilemma of mounting directional antennas in the proper angles around the axis of the post on which the array sits, and to maintain each shielded from adjacent antennas to minimize filed or beam overlap that would cause problems. Equally important is the ease of which the antennas may be installed at the correct radial positions on the pole and face angles so they properly communicate with others in the grid.

However, conventional cellular or mesh antenna systems offer little means of easily shielding and engaging the plurality of radially deployed dipole and other antennas, at a proper angle to others in the grid for full coverage.

Consequently, there is a continuing unmet need for an improved device and method for easy engagement of antennas in an array for mesh or cellular systems, which is adapted not only to engage the employed antennas and arrays at proper angles, it is also adapted to shield the antennas from each other.

Such a device should provide for an easy engagement of the antennas at the proper radial positioning around the pole axis to communicate with others in the system. Such a device in providing such a registered mounting should also provide shielding from adjacent antennas to avoid interference. Further, such a device should best be modular in that any antenna having a base may be adapted for easy mechanical engagement to the mount at the proper radial position, and face angle to communicate with others in the system.

### SUMMARY OF THE INVENTION

The device and method herein disclosed and described achieves the above-mentioned goals through the provision of modular components adapted for engagement to each other wherein the antennas are removably engageable to the pole at proper radially deployed positions and face angles to others in the grid or mesh.

A combination mount and shield component is adapted for engagement to a base at the top, or mid section of the pole elevating the device. A series of radially projecting fins project from a circular mounting plate to provide shielding. Centered between each pair of projecting fins, is a mounting track adapted to engage a rear of an antenna to be mounted. Additional engagements to the fins are provided on each side of the antenna to hold it securely and at proper face angles to other antennas in the grid.

Once the combination mount and shield is properly oriented on the pole to yield proper radial deployment of the antennas, the time consuming aiming of the installed antennas is eliminated and all radially deployed antennas are shielded from adjacent antennas. This is especially true for subsequent replacement antennas.

The combination mount and shield is formed of metal which is grounded to absorb the RF from antennas located between angled projecting fins from the mounting surface. Between the fins is a rail running parallel to the fins, which is adapted to engage a complimenting rail mount on the rear of the antenna being engaged. Projecting side mounts from the antenna, engage side mount connectors to thereby position the antenna at a correct radial deployment and face angle around the pole to properly communicate with downrange antennas in the grid.

Any number of fins may project from the mounting surface depending on the width of the antenna array being engaged therebetween. When used with modular antennas which may be formed on-site for custom frequency, gain, and beam angle, the device by providing a common mount for all such antennas installed, allows for repeat installation and removal at later dates for maintenance or to change frequencies of the installed antenna.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed antenna shield and mount. It is important, therefore, that the claims be regarded as including such equivalent construction and methodology insofar as they do not depart from the spirit and scope of the present invention.

It is an object of this invention to provide an antenna mount that has a common engagement component for all antennas to be employed therewith.

It is an additional object of this invention to provide such a modular antenna mount which also provides shielding for antennas located adjacently.

Yet an additional object is providing such a device which correctly radially positions the antenna so installed, and at a proper face angle, to communicate with other towers in the grid.

These together with other objects and advantages which become subsequently apparent reside in the details of the construction and operation as more fully hereinafter described and claimed, reference being had to the accompanying drawings forming a part thereof, wherein like numerals refer to like parts throughout.

Those skilled in the art will appreciate that the pioneering conception upon which this disclosure is based may readily be utilized as a basis for designing of other antenna mounting and shielding structures which allow the method herein and for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

FIG. 1 depicts an antenna tower having a radially engaged plurality of broadcast/receive antennas thereon in a conventional engagement.

FIG. 2 depicts a tower with a radome thereon for protection.

FIG. 3 is a top view showing the device herein, engaged to a base with fins in the proper radial deployment to position the antennas mounted therebetween in a proper radial position and face angle to others in the system.

FIG. 4 depicts a perspective of FIG. 3 showing the projecting fins which shield adjacent antennas from each other. Also shown is a shielded interior cavity to house transceivers.

FIG. 5 shows a perspective view of the device depicting the center mounting rail and side engagement rails which properly angle the generally planar antenna to others in the system.

FIG. 6 shows a view of the device herein as depicted in FIG. 5, where antenna arrays are engaged to the center rail and mounts on the projecting fins for proper face alignment and shielding.

### DETAILED DESCRIPTION OF THE PREFERRED EMBODIMENTS OF THE INVENTION

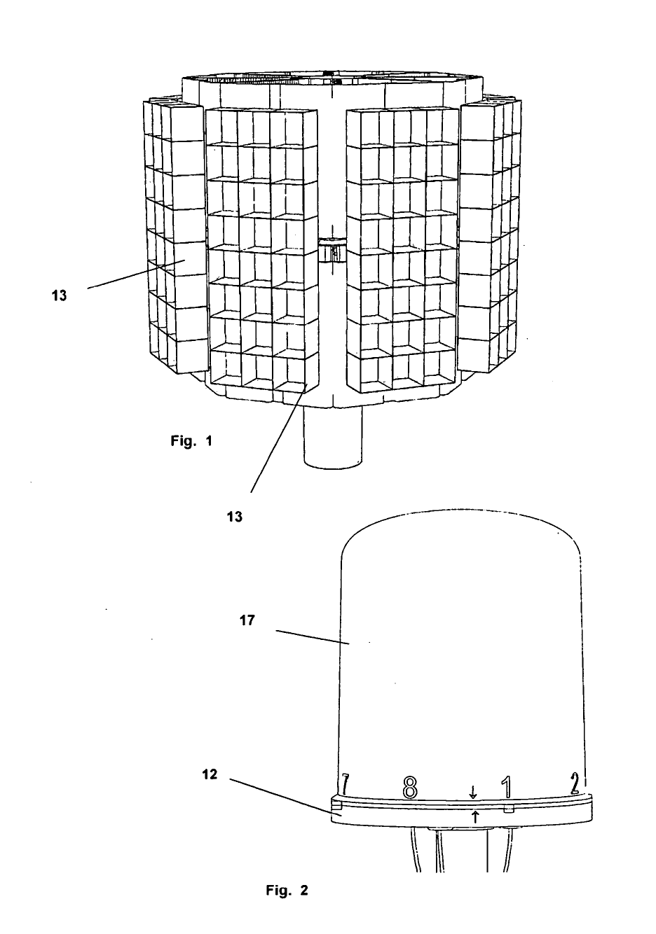

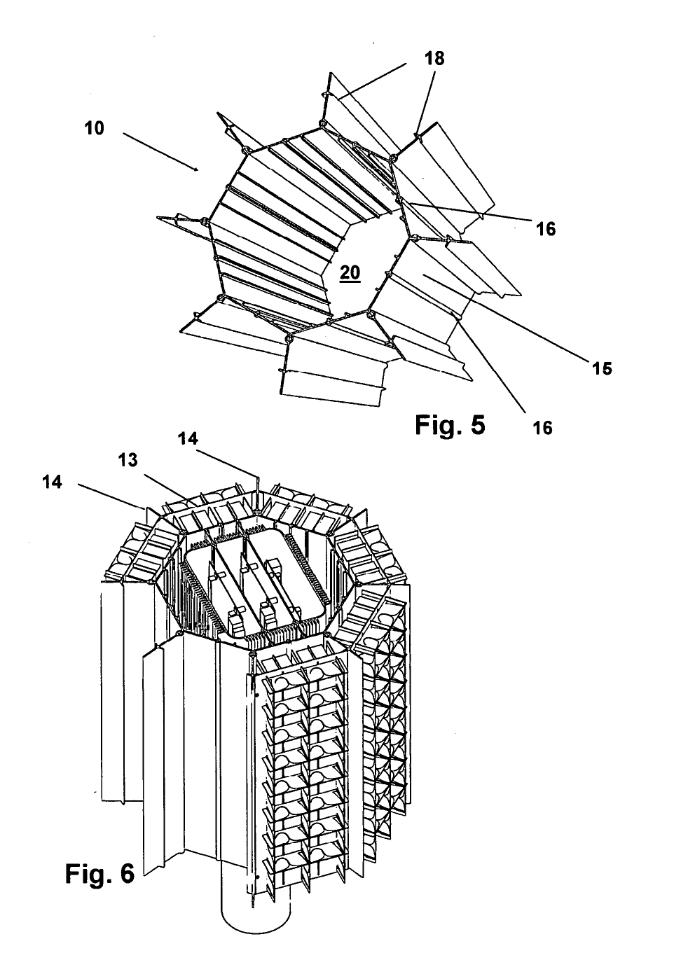

Referring now to the drawings of FIGS. 1-6, where similar components are references by like numerals, seen in FIG. 1 is an antenna tower having a radially engaged plurality of broadcast/receive antenna arrays positioned thereon. The antenna arrays must first be radially deployed around the pole in correct positions to communicate with others in the system. They then must be mounted and maintain their tangent plane to the pole and correct angle vertically and horizontally to maintain proper alignment with others in the wireless system. It can be time consuming and very hard to both mount the antennas radially in proper positions, and then place and maintain their face angles properly. Once finished, a radome 17 is conventionally installed for protection from the elements.

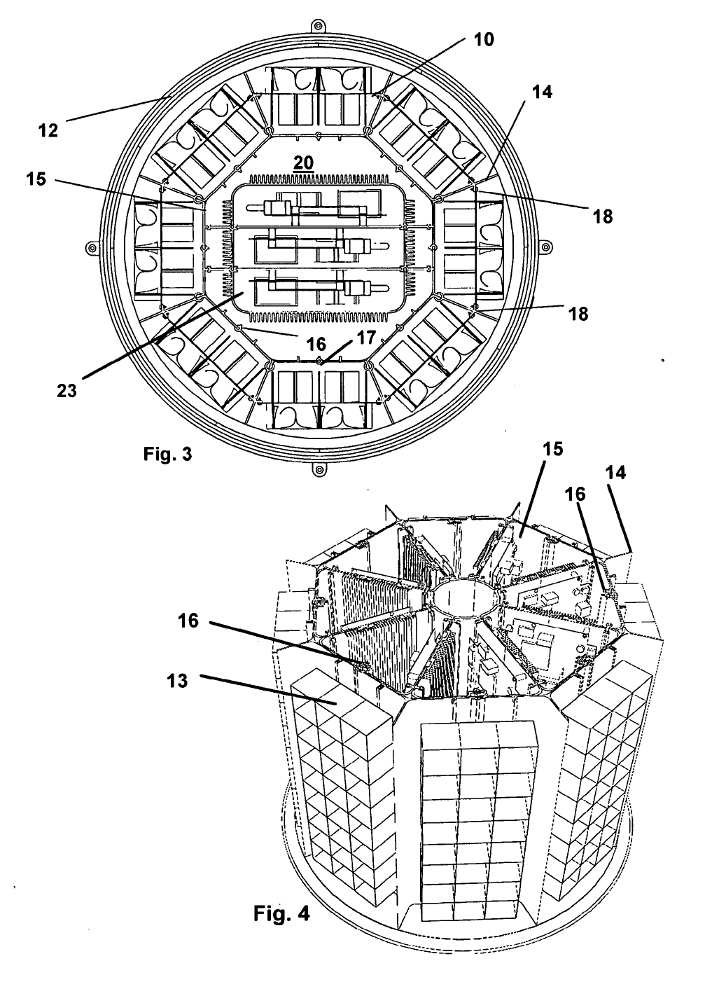

FIG. 3 is a top view showing the device 10 herein, engaged to a base 12. During the initial installation of the towers in the system, each combination mount and shield device 10 is engaged to its base 12 with the fins 14 in proper radial deployment around the pole. Proper deployment is such that the antennas 13 to be installed later, will engage the center mount 16 in a notch or registraton or other engagement 17 and/or at engagement points 18 on the fins 14 to be in the proper radial deployment to communicate with other antennas 13 in the mesh or grid. In one mode notches forming the engagement point 17 on the formed antenna 13 array exterior surface provides a combination engagement of both the center mount 16 and two side mounts with the fin engagement points 18 thereby providing a means to aim and perfectly position the antenna 13 and maintain its facial angle or plane, relative to the pole axis, to hold the antenna 13 in the proper operational position. Once the device 10 is properly enaged to the pole, repeatable antenna aiming is a simple procedure of engageing the notches or other engagement points 17 on the center mount 16, and fin engagement points 18.

Should replacement be necessary, it is a quick and simple job to install a similarly configured antenna 13 array to one or both of the center mount 16 and/or fin engagement points 18 and have it aligned to the system.

Also seen in FIGS. 3 and 4 are the fins 14 which are grounded, projecting past adjacent antennas 13 on both sides and thereby shielding them from each other. Further, the circular engagement wall which provides the position for the center mounts 16 also forms a fully shielded interior cavity 20 to protect the transceivers or network cards or other similar electronic equipment 23 from RF.

As viewed in FIGS. 4-6 the fins 14 shield adjacent antennas 13 from each other. The center mounts 16 run parallel to the pole axis and the engagement wall 15 provides a well-shielded cavity 20 for the electronics therein. Also shown in a shielded interior cavity 20 to house transceivers and side engagements 18.

While all of the fundamental characteristics and features of the combination antenna mount and shield have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

Consequently, all such modifications and variations and substitutions are included within the scope of the invention as defined by the following claims.

What is claimed is:

1. A combination antenna mount and shield for radially deployed elevated antennas, comprising:
a wall formed of material which is substantially impervious to Radio Frequency (RF) broadcasts and surrounding a central cavity;
plurality of fins radially projecting from front face of said wall, for a projection distance, and in a direction, away from said central cavity;
each pair of said fins defining a gap therebetween extending from said wall to distal edges of said fins;
means for engagement of said antenna to a mounted position in a said gap and positioning said antenna a distance from said wall which is less than said projection distance of said fins;
said cavity providing a means to shield electronic components placed therein from RF signals outside said cavity;
each said gap forming a means to protect a said antenna in a said mounted position therein, from RF signals from sources on opposite sides of said fins from said gap; and
whereby electronic equipment placed in said central cavity is provided protection from said RF signals exterior to said central cavity and each said antenna in said mounted position is provided a shield from RF signals from adjacent said antennas in adjacent said gaps.

2. The combination antenna mount and shield for radially deployed elevated antennas of claim 1 wherein said means for engagement of said antenna to a mounted position in a said gap comprises:
an attachment point on said wall between each said pairs of radially extending fins, said attachment point adapted to engaged said antenna.

3. The combination antenna mount and shield for radially deployed elevated antennas of claim 1 wherein said means for engagement of said antenna to a mounted position in a said gap comprises:
an attachment position on a surface of each of said pairs of fins radially projecting from said wall; and
said attachment positions adapted to engaged two sides of an antenna to said engaged position in said gap.

4. The combination antenna mount and shield for radially deployed elevated antennas of claim 2, wherein said means for engagement of said antenna to a mounted position in a said gap comprises:
an attachment position on a surface of each of said pairs of fins radially projecting from said wall; and
said attachment positions adapted to engaged two sides of an antenna to said engaged position in said gap.

5. The combination antenna mount and shield for radially deployed elevated antennas of claim 4, additionally comprising:
said means for engagement of said antenna to said mounted position also providing means to properly aim said antenna during an initial or replacement engagement of said antenna in said gap.
